(19) United States
(12) Patent Application Publication
(10) Pub. No.: US 2024/0001729 A1
(43) Pub. Date: Jan. 4, 2024

(54) VEHICLE AXLE WITH AIR DEFLECTION ELEMENTS AND ANTI-STRIKE PROTECTION

(71) Applicant: AUDI AG, Ingolstadt (DE)

(72) Inventors: Tobias KRAMER, Stammham (DE); Sebastian SCHINDLER, Ingolstadt (DE)

(21) Appl. No.: 18/250,616

(22) PCT Filed: Nov. 30, 2021
(86) PCT No.: PCT/EP2021/083612

§ 371 Date: Apr. 26, 2023

(30) Foreign Application Priority Data
Jan. 13, 2021 (DE) 102021100479.9

(51) Int. Cl. B60G 21/00; B62D 7/22; B60T 5/00; F16D 65/847

(52) U.S. Cl. CPC B60G 21/005; B62D 7/228; B60T 5/00; F16D 65/847; B60G 2202/134; B60G 2202/135; B60G 2206/427; B60G 2206/80

(57) ABSTRACT

The invention relates to a vehicle axle for a motor vehicle. Two wheel carriers, each guided on an axle guide and pivotable by a tie rod, each having a wheel brake. At least one air deflection element per wheel brake, which deflects a travel air flow in the direction of the wheel brake for brake cooling. The air deflection element is fastened on the wheel carrier, on an axle guide, or on the tie rod. A stabilizer for reducing rolling movements of the motor vehicle. The stabilizer includes protective elements arranged in the area of the air deflection elements, which prevent direct striking of the air deflection elements on the stabilizer during steering and/or spring movements.

### FIELD

The invention relates to a vehicle axle for a motor vehicle.

### BACKGROUND

A vehicle axle in question includes at least one air deflection element or air guiding element per wheel brake, which deflects travel air flow in the direction of the wheel brake in question for brake cooling.

DE 10 2005 005 113 A1 describes a deflection element (1) for supplying air to a brake disk (wheel brake). The deflection element (1) is fastened on a wheel guiding arm (2) and is locally equipped with elastic strike areas (A1, A2), so that no damage and/or obstruction of vehicle components can take place during movement sequences due to steering processes and compression and extension.

### SUMMARY

Proceeding from this prior art, the vehicle axle according to the invention offers the stabilizer very good protection from damage due to air deflection elements which are arranged in the area of the stabilizer, without this being accompanied by noteworthy additional costs or relevant additional weight. Refinements and embodiments of the vehicle axle according to the invention result from the dependent claims, the following description of the invention (wherein this expressly also includes features which are described as “for example”, “preferably”, “in particular”, etc.), and the drawing.

A vehicle axle according to the invention (which can also be designated as an axle system), wherein it is in particular a front axle, comprises at least the following components or devices:
two wheel carriers, each guided on at least one axle guide and pivotable or steerable by means of (at least one) tie rod (which can also be formed in multiple parts), in particular a right wheel carrier and a left wheel carrier, each having a wheel brake;
possibly an auxiliary frame, on which the axle guides (having the wheel carriers) are suspended;
at least one air deflection element per wheel brake, which deflects a travel air flow in the direction of the wheel brake in question for the purpose of brake cooling, wherein the air deflection element is fastened on the (associated) wheel carrier, on an axle guide (of the wheel carrier), or on the tie rod, wherein at least one air deflection element is provided for the right wheel brake or at least one air deflection element is provided for the left wheel brake;
a stabilizer for reducing rolling movements of the motor vehicle.

The vehicle axle according to the invention thus includes (at least) two wheel brakes, in particular a right wheel brake and a left wheel brake, and (at least) two air deflection elements, in particular a right air deflection element for the right wheel brake and the left air deflection element for the left wheel brake.

According to the invention, it is provided that the stabilizer includes protective elements arranged in the area of the air deflection elements, which prevent direct striking of the air deflection elements on the stabilizer during steering and/or spring movements (of the axle components). At least one protective element arranged on the stabilizer is provided for each air deflection element (which could strike on the stabilizer), as explained in more detail hereinafter.

The vehicle axle according to the invention is preferably a vehicle axle for passenger vehicle or for a light utility vehicle (for example for a so-called light truck or small van). The vehicle axle according to the invention is designed in particular as a front axle.

A wheel carrier designates an axle component on which a vehicle wheel and the wheel brake, in particular the brake caliper, are fastened. Wheel or axle guides designate struts or the like which are connected, in particular articulated, with a wheel carrier, and via which the wheel carrier is movably suspended or guided. An axle or auxiliary frame designates a structural unit, in particular formed from longitudinal beams and crossbeams, on which the wheel guides are fastened or mounted (at their ends facing away from the wheel carriers), in particular movably. A stabilizer designates a device which is supposed to reduce the rolling movements of the vehicle or motor vehicle in a known manner, in that the compression movement of a vehicle wheel is quasi-transmitted to the opposite wheel, for example via a spring element designed as a torsion bar or torsion spring, for which purpose various embodiments are known from the prior art. A tie rod is understood as a one-piece or multi-piece device, which transmits steering movements, in particular originating from a steering gear, to the wheel carriers and vehicle wheels.

An air deflection element designates, as already explained at the outset, an air guiding element which is provided to deflect a travel air flow (at least fractionally) in the direction of a wheel brake for brake cooling. The air deflection elements of the vehicle axle according to the invention are preferably designed as shell parts, in particular as blade-like shell parts, and are preferably manufactured from metal, in particular from sheet metal, or from plastic, in particular from fiber-reinforced plastic. They are preferably one-piece plastic injection molded parts.

In the vehicle axle according to the invention, the air deflection elements are arranged, in particular because of design and/or installation space, in such a way that they can strike on the stabilizer during steering and/or spring movements (of the wheel carriers, the axle guides, and/or the tie rod). However, this is prevented according to the invention in that the stabilizer is equipped with at least one protective element in each of the areas in question in which the air deflection elements could strike. These protective elements function as quasi-anti-strike protections or strike cushions for the air deflection elements, by which damage to the stabilizer is effectively prevented. Furthermore, comparatively large-area air deflection elements can be used, which are particularly efficient for brake cooling.

The deflection elements having elastic strike areas described in DE 10 2005 005 113 A1 are less effective for the requirements in question here, since they could still strike, so that the desired protective effect cannot be ensured.

The protective elements arranged on the stabilizer or preferably designed in such a way that a minimum distance of 5 mm to 10 mm, in particular of 5 mm to 8 mm, is ensured between the air deflection elements and the stabilizer (or the stabilizer tube; see below), in particular at each point.

The stabilizer is preferably formed from a stabilizer tube (or the like), preferably from a steel tube, wherein the protective elements are arranged on the outer circumference of this stabilizer tube.

The stabilizer or the stabilizer tube is preferably formed from metal, in particular steel, and is provided with a corrosion protection coating, wherein the protective elements are in particular supposed to protect the corrosion protection coating from damage.

The stabilizer, in particular the stabilizer tube, is preferably formed having angled stabilizer ends, which can also be designated as stabilizer legs and which function in a known manner as lever arms. In particular, it is then provided that the protective elements are arranged on the angled stabilizer ends or stabilizer legs and are supposed to protect them.

The protective elements can be formed as elastomer or plastic pads which are attached to the relevant points on the stabilizer or on the stabilizer tube, for example adhesively bonded. Pads designate cushion-like or buffer-like protective elements, which are in particular designed and attached in such a way that the stabilizer or the stabilizer tube is only covered on part of the circumference at the relevant points. The protective elements can also be formed as elastomer or plastic rings, which includes the entire circumference of the stabilizer or the stabilizer tube at the relevant points. The elastomer or plastic rings can be elastically expanded and pulled or pushed onto the stabilizer or the stabilizer tube. The mounting is performed by elastic clamping forces. In addition, adhesive bonding can be carried out to prevent twisting and/or displacement.

The protective elements, in particular in the form of pads or rings (see above), can be formed from an elastomer, in particular from an aging-resistant elastomer, or from a plastic, in particular from an aging-resistant plastic. It is preferably provided that these protective elements formed from an elastomer or from plastic are vulcanized or sprayed onto the stabilizer or the stabilizer tube, so that the stabilizer or the stabilizer tube and the protective elements are formed quasi-integrally.

If the stabilizer or the stabilizer tube includes a coating, preferably a corrosion protection coating (see above), it is thus provided in particular that the protective elements, in particular in the form of pads or rings (see above), are applied to this coating, in particular adhesively bonded or vulcanized or sprayed on. Furthermore, high tearing off forces can be ensured by the vulcanizing or spraying on.

The protective elements, in particular in the form of pads or rings (see above), can be formed having shape-matched strike surfaces for the air deflection elements. This means in particular that the protective elements are matched in areas to the contour of an inner surface of the relevant air deflection element facing toward the stabilizer or the stabilizer tube, by which planar striking is enabled.

The invention is explained in more detail hereinafter in a nonrestrictive manner on the basis of the drawings. The features shown in the figures of the drawings and/or explained hereinafter can be general features of the invention, also independently of the specific feature combinations, and can refine the invention accordingly. The possible embodiments explained hereinafter can expressly also be combined with one another.

### BRIEF DESCRIPTION OF THE FIGURES

FIG. 1 shows a perspective illustration in detail of the left-side area of the vehicle axle according to the invention.

FIG. 2 shows another perspective illustration (according to arrow A in FIG. 1) of the left-side air deflection element of the vehicle axle of FIG. 1 and a first preferred possible embodiment of the invention.

FIG. 3 shows a second preferred possible embodiment of the invention analogously to FIG. 2.

### DETAILED DESCRIPTION

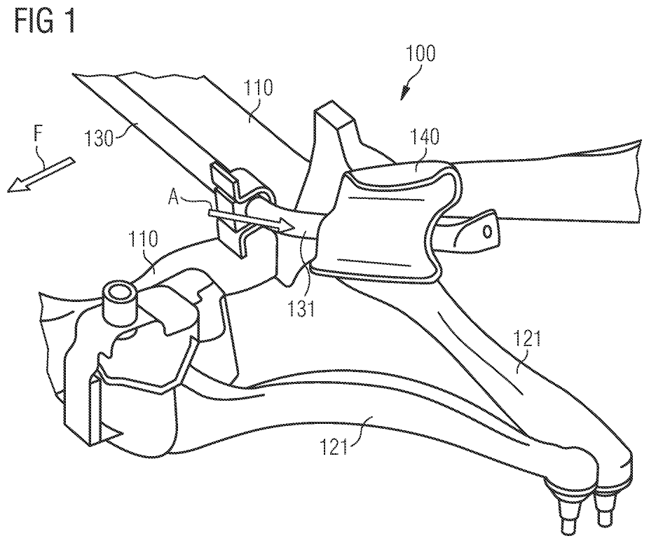

FIG. 1 shows the left-side area of a vehicle axle 100 according to the invention, which is designed, for example, as a McPherson axle. The axle 100 shown is a front axle. The forward travel direction of the motor vehicle is indicated by the arrow F. The right-side area of the vehicle axle 100 is constructed substantially mirror symmetrically, i.e., the following explanations apply analogously to the right-side axle area. Furthermore, reference is also made to the prior art, in particular to DE 10 2005 005 113 A1.

The vehicle axle 100 shown includes an auxiliary frame 110, on which multiple lower axle guides 121 are movably fastened on the left axle side shown (possible upper axle guides are not shown). A lift wheel carrier (not shown) having a left wheel brake is fastened and guided on these axle guides 121, wherein the wheel brake is designed in particular as a disk brake (as shown, for example, in DE 10 2005 005 113 A1). The left wheel carrier is pivotable or steerable by means of a tie rod (also not shown). As already explained, the right axle side (not shown) is constructed essentially mirror symmetrically.

The vehicle axle 100 furthermore includes a stabilizer 130, which is formed from a stabilizer tube and includes angled stabilizer ends 131. The stabilizer ends 131 are connected directly or indirectly (for example via a coupling rod) to a bumper or an upper axle guide, wherein other stabilizer attachments known from the prior art are also possible.

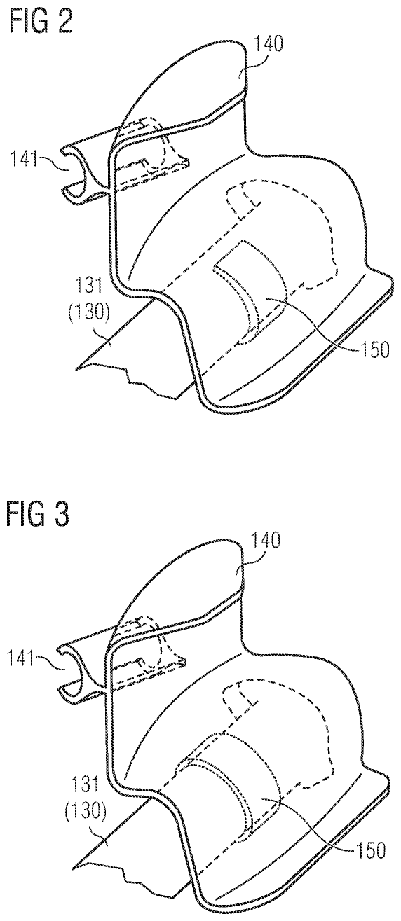

Furthermore, a left-side air deflection element 140 is provided, which deflects a travel air flow incoming counter to the travel direction F in the direction of the left wheel brake for the purpose of brake cooling. The dimensionally stable air deflection element 140 is fastened on the tie rod 130. The fastening is carried out by clipping on (see clip bracket 141 in FIGS. 2 and 3) and/or screwing on. With corresponding axle construction, fastening on the wheel carrier, on one of the lower axle guides 121, on an upper axle guide, or the like is also possible in principle. Similarly thereto, a right-side air deflection element is also provided, which deflects the travel air flow in the direction of the right wheel brake. Multiple such air deflection elements can also be provided per wheel brake.

In order that the air deflection element 140 does not strike against the stabilizer or the stabilizer tube 130 during steering and/or spring movements, it is provided that a protective element 150 functioning as a quasi-anti-strike protection or strike buffer is attached to the stabilizer 130 in the area or in a possible contact area of the air deflection element 140, thus at the angled stabilizer and/or leg 131. Multiple such protective elements 150 can also be attached, wherein in particular as few protective elements as possible are provided. The protective element 150 prevents direct striking of the air deflection element 140 on the stabilizer 130. This also applies analogously to the right air deflection element (not shown).

FIG. 2 shows a first possible embodiment in which the protective element 150 is designed as a crescent-like elastomer or plastic pad, which encloses part of the circumference of the stabilizer or the stabilizer tube 130 and quasi-protrudes into the empty space between the air deflection element 140 and the stabilizer end 131. The pad 150 is preferably adhesively bonded or vulcanized or sprayed onto the stabilizer or the stabilizer tube 130, as explained above.

FIG. 3 shows a second possible embodiment, in which the protective element 150 is designed as an elastomer or plastic ring, which encloses the entire circumference of the stabilizer or the stabilizer tube 130. The ring 150 is preferably pulled or vulcanized or sprayed (extrusion coating) onto the stabilizer or the stabilizer tube 130, as explained above.

The protective element 150 designed as a pad or ring can have a height (in the radial direction) of 5 mm to 10 mm, in particular of 5 mm to 8 mm, by which a corresponding minimum distance is insured between air deflection element 140 and stabilizer 130 or stabilizer end 131. The protective element 150 can have a width (in the axial direction) of 3 to 15 mm, in particular of 5 mm to 10 mm. The width has influence on the holding force, which is to be sufficiently high that twisting and/or displacement is prevented. The protective element 150 is preferably designed to be as small and light as possible.

As explained above, the protective element 150 can also be designed having a defined shape-matched or contour-matched strike surface for the air deflection element 140, so that the air deflection element 140 does not strike in points, but rather in a planar manner.

1-10. (canceled)

11. A vehicle axle for a motor vehicle, comprising:
two wheel carriers, each guided on an axle guide and pivotable by a tie rod, each having a wheel brake;
at least one air deflection element per wheel brake, which deflects a travel air flow in the direction of the wheel brake for brake cooling, wherein the air deflection element is fastened on the wheel carrier, on an axle guide, or on the tie rod;
a stabilizer for reducing rolling movements of the motor vehicle;
wherein the stabilizer includes protective elements arranged in the area of the air deflection elements, which prevent direct striking of the air deflection elements on the stabilizer during steering and/or spring movements.

12. The vehicle axle as claimed in claim 11, wherein the protective elements are designed in such a way that a minimum distance of 5 mm to 10 mm is ensured between the air deflection elements and the stabilizer.

13. The vehicle axle as claimed in claim 11, wherein the stabilizer is formed from a stabilizer tube, wherein the protective elements are arranged on the outer circumference of the stabilizer tube.

14. The vehicle axle as claimed in claim 11, wherein the stabilizer is formed from metal and includes a corrosion protection coating.

15. The vehicle axle as claimed in claim 11, wherein the stabilizer is formed having angled stabilizer ends, wherein the protective elements are arranged at the angled stabilizer ends.

16. The vehicle axle as claimed in claim 11, wherein the protective elements are designed as elastomer or plastic pads.

17. The vehicle axle as claimed in claim 11, wherein the protective elements are designed as elastomer or plastic rings.

18. The vehicle axle as claimed in claim 11, wherein the protective elements are formed from elastomer or plastic and are vulcanized or sprayed onto the stabilizer.

19. The vehicle axle as claimed in claim 11, wherein the protective elements are designed having shape-matched strike surfaces for the air deflection elements.

20. The vehicle axle as claimed in claim 11, wherein the vehicle axle is a front axle.

21. The vehicle axle as claimed in claim 12, wherein the stabilizer is formed from a stabilizer tube, wherein the protective elements are arranged on the outer circumference of the stabilizer tube.

22. The vehicle axle as claimed in claim 12, wherein the stabilizer is formed from metal and includes a corrosion protection coating.

23. The vehicle axle as claimed in claim 13, wherein the stabilizer is formed from metal and includes a corrosion protection coating.

24. The vehicle axle as claimed in claim 12, wherein the stabilizer is formed having angled stabilizer ends, wherein the protective elements are arranged at the angled stabilizer ends.

25. The vehicle axle as claimed in claim 13, wherein the stabilizer is formed having angled stabilizer ends, wherein the protective elements are arranged at the angled stabilizer ends.

26. The vehicle axle as claimed in claim 14, wherein the stabilizer is formed having angled stabilizer ends, wherein the protective elements are arranged at the angled stabilizer ends.

27. The vehicle axle as claimed in claim 12, wherein the protective elements are designed as elastomer or plastic pads.

28. The vehicle axle as claimed in claim 13, wherein the protective elements are designed as elastomer or plastic pads.

29. The vehicle axle as claimed in claim 14, wherein the protective elements are designed as elastomer or plastic pads.

30. The vehicle axle as claimed in claim 15, wherein the protective elements are designed as elastomer or plastic pads.
